(19) United States
(12) Patent Application Publication
(10) Pub. No.: US 2023/0370748 A1
(43) Pub. Date: Nov. 16, 2023

(54) Signal Processing for Infra-Red Imaging Technology (SPIRIT) Architecture for Small, Mid-size, and Large format Focal Plane Arrays

(71) Applicant: Government of the United States, as represented by the Secretary of the Air Force, Wright-Patterson AFB, OH (US)

(72) Inventors: Mohammad Vaik, Beavercreek, OH (US); Joshua Duran, Dayton, OH (US); Andrew Wegener, Dayton, OH (US); John Derov, Beavercreek, OH (US); Jarrett Vella, New Carlisle, OH (US)

(73) Assignee: Government of the United States, as represented by the Secretary of the Air Force, Wright-Patterson AFB, OH (US)

(21) Appl. No.: 18/316,753

(22) Filed: May 12, 2023

Related U.S. Application Data
(60) Provisional application No. 63/341,144, filed on May 12, 2022.

(51) Int. Cl. H04N 25/76; H04N 25/709

(52) U.S. Cl. CPC H04N 25/7795; H04N 25/709

(57) ABSTRACT

A universal Read-Out Integrated Circuit (ROIC) interface apparatus configurable to control each of a plurality of different types of ROICs, each type of ROIC being configured to operate as an optical frontend to a respective optical detector array, the universal ROIC interface comprising a Pulse Capture Electronics (PCE) system or sub-system including a power subsystem, a ROIC data receive interface, a clock management system, and a signal processor integrated together, such as on a common printed circuit board (PCB).

### CROSS-REFERENCE TO RELATED APPLICATIONS

This application claims priority to U.S. Provisional Application 63/341,144, filed on May 12, 2022, which is incorporated herein by reference in its entirety.

### GOVERNMENT INTEREST

The invention described herein was made by employees of the United States Government and may be manufactured and used by or for the Government of the United States of America for governmental purposes without the payment of any royalties.

### FIELD OF THE INVENTION

The present disclosure generally relates to pulse capture electronics (PCE) of an imaging system for rendering and computational processing.

### BACKGROUND OF THE INVENTION

Passive Electro-Optical/Infra-Red (EO/IR) imagers, in general, consist of several subsystems such as the one shown in FIG. 1; namely, a Focal Plane Array (FPA) 100 consisting of an optical detector array 102 bonded to a Read-Out Integrated Circuit (ROIC) 104, and Signal Processing Electronics (SPE) 106 consisting of Pulse Capture Electronics (PCE) 108 and a computer 109 (illustrated as a single board computer (SBC) or personal computer (PC)) having Data Acquisition (DAQ) system 110 thereon.

The detector array 102 senses optical radiation and responsively generates electrical signals that are received or “read” by the ROIC 104 to provide output image data 114. That is, the ROIC 104 generates output data representing detector intensity or image data 114, which may be digital or analog depending upon the ROIC used. The ROIC 104 operates as an optical frontend for the detector array 102.

The PCE 102 formats and processes (via processor 111) the output image data 114 received from the ROIC 104 so as to provide formatted or processed data to the DAQ 110 or other backend processing subsystem (illustrated as the SBC/PC 109 but alternatively a computer programmed for displaying the image data or signal processing for further analysis). The PCE, as illustrated, further includes a controller 113 and a timer 115.

A turnkey imaging system will include the optical frontend (e.g., the ROIC 104) PCE 102 with required power supplies, control signals, and some interface hardware and software combination to communicate with the DAQ hardware 110 and a DAQ software (SW) 112. The PCE 108, as shown in FIG. 1, includes power supplies (not shown), required signals, and an interface (not shown) to the SBC/PC 109; however, the frontend interface is generally targeted for an optical frontend so as to interface with a certain ROIC model from a given vendor.

In most cases the PCE 108 is designed on multiple cards as integrated hardware and not as a single card that can be removed and plugged into another optical frontend. Conventional ROICs 104, PCEs 108, and rendering hardware and software are commercial off-the-shelf (COTS) products that are not specialized for use with specific detector technologies. That is, in order to be a turnkey system, the PCE 108 is designed to accommodate most general hardware utilizing multiple cards and cable options and is not targeted for a small footprint, low power, or customized for a particular ROIC. 104

The conventionally available PCE 108 may not even work for all the optical frontends by the same manufacturer and is extremely unlikely to work for optical frontends by a different manufacturer. This is due to the optical frontend consisting of an FPA that is a combination of the two-dimensional detector array 102 and the ROIC. 104. The interface to the optical frontend is defined by the ROIC 104 that is used. The design of the ROIC 104 is dependent on the size of the detector array 102, which translates into the data rates out of the ROIC 104, the various voltage levels that are required by the ROIC 104, and the detector array 102, associated control signals placed by the designer, and speed or timing (internal clock) of the ROIC 104.

Turnkey PCE systems 108 are sold as boxes with card slots such that different cards are purchased for a specific FPA 100. These boxes are bulky and thus not suited for applications where there is limited space on an airborne or space borne platform where a single board architecture is preferred. These boxes are also not open architecture and use proprietary software to capture the imaging data 114. The DAQ hardware 110 and DAQ-SW 112 are usually a combination of both COTS hardware and a vendor-developed software utility. The DAQ hardware and software 110, 112 are limited to a certain data rate and format; the software utility, in general, is geared towards a set number of data formats. The DAQ-SW 112 cannot be modified for domain-specific signal processing.

The inability to use standard software, such as Python or Matlab, hinders advanced testing of the optical frontends and restricts a user to a standard proprietary interface for designing and configuring tests. The size of these boxes makes them impractical for platforms that are space limited, such as UAVs and handheld applications.

There remains a need for improvements to be made.

### SUMMARY OF THE INVENTION

Various deficiencies in the prior art are overcome by a universal Read-Out Integrated Circuit (ROIC) interface apparatus configurable to control each of a plurality of different types of ROICs, each type of ROIC being configured to operate as an optical frontend to a respective optical detector array, the universal ROIC interface comprising a Pulse Capture Electronics (PCE) system or sub-system including a power subsystem, a ROIC data receive interface, a clock management system, and a signal processor integrated together, such as on a common printed circuit board (PCB). The common PCB may also have integrated thereon a System Configuration and Data Acquisition (SCDAQ) system or sub-system configured to control the PCE, such as to cause the PCE interface with, control, and/or test a specific ROIC or Focal Plane Array (FPA).

According to embodiments of the present invention, a PCE system configured to control a target ROIC. The target ROIC being configured to operate as an optical frontend to a respective optical detector array. The PCE includes an ROIC data receive interface, a clock management system, and a signal processor. The ROIC data receive interface is configured to provide a plurality of available physical layer channels for coupling to a corresponding plurality of ROIC physical layer output channels for receiving an optical intensity level representative electrical signal from the target ROIC. The clock management system configured to generate a clock signal for the target ROIC, the clock signal configured to enable communication between the ROIC data receive interface and the target ROIC. The signal processor configured to receive control information associated with the target ROIC and responsively configure the ROIC data receive interface, the clock management system, or both.

A universal ROIC interface, apparatus, and system according to various embodiments may be portable and comprise PCE and SCDAQ subsystems configured to interface with small, mid-size, and large format Focal Plane Arrays. The universal ROIC interface/apparatus/system allows the reconfiguration and customization necessary ensuring the capability to interface, control, and test ROIC from multiple ROIC designs for optical front ends from different vendors.

In one embodiment, a universal ROIC interface apparatus is configurable to control a target ROIC from different types of ROICs, each of the different types of ROIC being configured to operate as an optical frontend to a respective optical detector array, the universal ROIC interface comprising: a PCE system, comprising: a power subsystem configured to generate for the target ROIC type a power signal having a selected power level; a ROIC data receive interface configured to provide a plurality of available physical layer channels for coupling to a corresponding plurality of ROIC physical layer output channels for receiving from the target ROIC an optical intensity level representative electrical signal; a clock management system configured to generate for the target ROIC a clock signal configured to enable communication between the ROIC data receive interface and the target ROIC; and a signal processor configured to receive control information associated with the target ROIC and responsively configure the power subsystem, the ROIC data receive interface, and the clock management system.

Additional objects, advantages, and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated in and constitute a part of this specification, illustrate embodiments of the present invention and, together with a general description of the invention given above, and the detailed description of the embodiments given below, serve to explain the principles of the present invention.

FIG. 1 depicts is a high-level functional block diagram of a generally known Signal Processing Electronics (SPE) assembly that interfaces to a Focal Plane Array (FPA) according to the prior art.

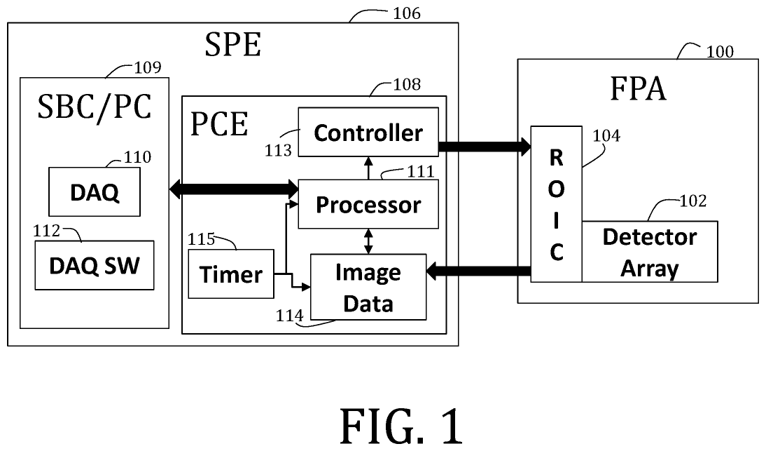

FIG. 2 is a functional block diagram of a universal Read-Out Integrated Circuit (ROIC) interface, according to various embodiments.

FIG. 3 is a block diagram of subsystem physical layers of the universal ROIC interface apparatus, according to one or more embodiments.

FIG. 4 graphically represents a method of generating a hardware specific configuration suitable for use in the PCE 300 of FIG. 3.

FIG. 5 graphically represents a method of generating an output image data file suitable for use in the PCE 300 of FIG. 3.

FIG. 6 is a high-level subsystem block diagram of passive Electro-Optical/Infra-Red (EO/IR) imager in accordance with various embodiments.

FIG. 7 is a high-level block diagram for a PCE including the DAQ system, according to one or more embodiments.

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION OF THE INVENTION

The following description and drawings merely illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be only for illustrative purposes to aid the reader in understanding the principles of the invention and the concepts contributed by the inventor(s) to furthering the art and are to be construed as being without limitation to such specifically recited examples and conditions.

Various deficiencies in the prior art are overcome by a universal Read-Out Integrated Circuit (ROIC) interface configurable to control each of a plurality of different types of ROICs, according to the various embodiments described herein. Each type of ROIC is configured to operate as an optical frontend to a respective optical detector array. The universal ROIC interface comprises a Pulse Capture Electronics (PCE) system or sub-system including a power subsystem, a ROIC data receive interface, a clock management system, and a signal processor integrated together, such as on a common printed circuit board (PCB). The common PCB may also have integrated thereon a System Configuration and Data Acquisition (SCDAQ) system or sub-system configured to control the PCE, such as to cause the PCE interface with, control, and/or test a specific ROIC or Focal Plane Array (FPA).

The universal ROIC interface, apparatus, and system, according to various embodiments, may be portable and comprise the PCE and the SCDAQ subsystems configured to interface with small, mid-size, and large format FPAs. The universal ROIC interface, apparatus, and system allow the reconfiguration and customization necessary ensuring the capability to interface, control, and test ROIC from multiple ROIC designs for optical front ends from different vendors.

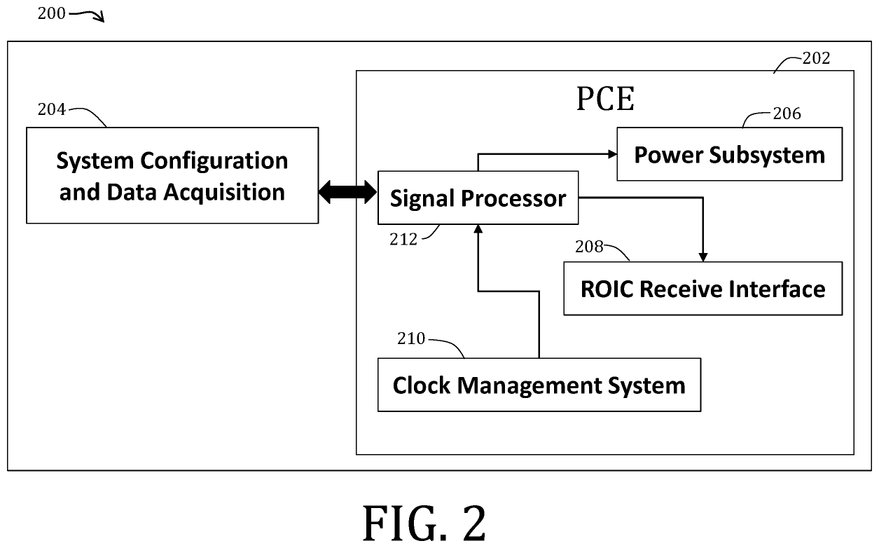

Referring now to the figures, in particular FIG. 2 is a functional block diagram of a universal ROIC interface 200, according to one embodiment of the present invention. The universal ROIC interface 200 of FIG. 2 is embodied as a portable apparatus or system comprising a PCE 202 and a SCDAQ system 204. As depicted in FIG. 2, the PCE 202 comprises a power subsystem 206, a ROIC data receive interface 208, a clock management system 210, and a signal processor 212.

The power subsystem 206 is configured to generate for a target ROIC type power signals (not shown in FIG. 2), each power signal having a selected power level. Generally speaking, the power subsystem 206 provides various automated reconfigurable power levels that can be sequenced for boot up or shut down requirements for a given optical frontend.

The ROIC data receive interface 208 is configured to provide a plurality of available physical layer channels for coupling to a corresponding ROIC physical layer output channels (not shown) for receiving from a target ROIC optical intensity level representative electrical signals. Generally speaking, the ROIC data receive interface 208 comprises multiple channels (physical layer) where the connection to a ROIC (not shown) may use single, multiple but not all (i.e., some), or all channels to read, and digitize if required, the intensity levels coming out of a FPA (not shown) for an analog or digital ROIC (not shown).

The clock management system 210 is configured to generate for the target ROIC type clock signals having characteristics selected to enable communication between the ROIC data receive interface 208 and the target ROIC (not shown). Generally speaking, the clock management system 210 comprises multiple clock generators (physical layer) that can be used to generate single or multiple clocks that maybe required for a desired system configuration.

The signal processor 212 is configured to receive control information associated with the target ROIC type and responsively configure the power subsystem 206, ROIC data receive interface 208, clock management system 210, or combinations thereof as needed, to enable the ROIC interface functions described herein. Generally speaking, the signal processor 212 is configured to program or configure or otherwise cause the PCE 202 to operate in a manner compatible with a particular type of target ROIC (not shown).

The SCDAQ system 204 may include a computing device (not shown) having physical and firmware or software layers that provide system configuration to the PCE 202 (such as with respect to a target ROIC or ROIC type) and communicates data with the PCE 202, such as receiving image data associated with a FPA interfaced with the PCE 202. The received image data may be displayed on a display device (not shown), transferred to local or remote processing devices (not shown), or processed by the SCDAQ system 204 in accordance with some data acquisition, testing, sensing, or other purpose. Generally speaking, the SCDAQ system 204 enables system reconfiguration (i.e., PCE reconfiguration) for interfacing the same ROIC interface 208 to any of a plurality of different types of ROICs or ROIC optical front ends, such as with varying parameters for image collection, optical array powering, array scanning, and so on.

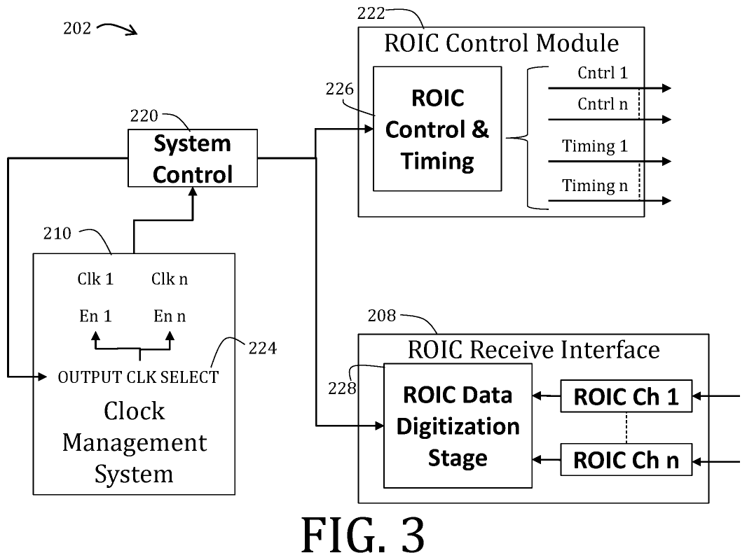

FIG. 3, with continued reference to FIG. 2, is a block diagram of the PCE 202 according to an embodiment and that is suitable for use in the universal ROIC interface 200. Specifically, the PCE 202 of FIG. 3 is depicted as comprising the clock management system 210, a system control 220 incorporating the signal processor 212, the power subsystem 206, an ROIC control module 222, and the ROIC data receive interface 208.

As depicted in FIG. 3, the clock management system 210, responsive to control signaling (e.g., an Output Clock Select signal 224, illustrated as “Output Clk Select”) from the system control 220, generates output clock signals (e.g., a System Clock signal). As depicted, a plurality (n) of output clock generators (CLK₁ through CLK_{N}) are enabled or selected via a corresponding plurality (n) of enabling circuits (En₁ through Enₙ) in response to the Output Clock Select signal 224.

The system control 220 generates the Output Clock Select 224 signal in accordance with a desired ROIC or ROIC type and receives the System Clock signal from the system clock management system 210. The system control 220 also generates control signaling for the power subsystem 206 (FIG. 2) and the ROIC control module 222, which causes a ROIC control and timing module 226 to generate control signals (illustrated as “Cntrl 1” through “Cntrl n”) and timing signals (illustrated as “Timing 1” through “Timing n”) appropriate to drive the desired or target ROIC or ROIC type (i.e., appropriate to cause the FPA to generate image-related data.

The ROIC data receive interface 208, responsive to control signaling from the system controls 220, receives optical intensity level representative electrical signals from the desired or target ROIC or ROIC type via physical digital or analog input channels (illustrated as “ROIC CH₁” through “ROIC CHₙ”). An ROIC data digitization stage 228 optionally converts the received optical intensity level representative electrical signals (e.g., the image information received from the FPA) into data bytes/signals for transmission to the system controls 220 for further processing or retransmission to a SCDAQ system 204 (FIG. 2) or other device or entity.

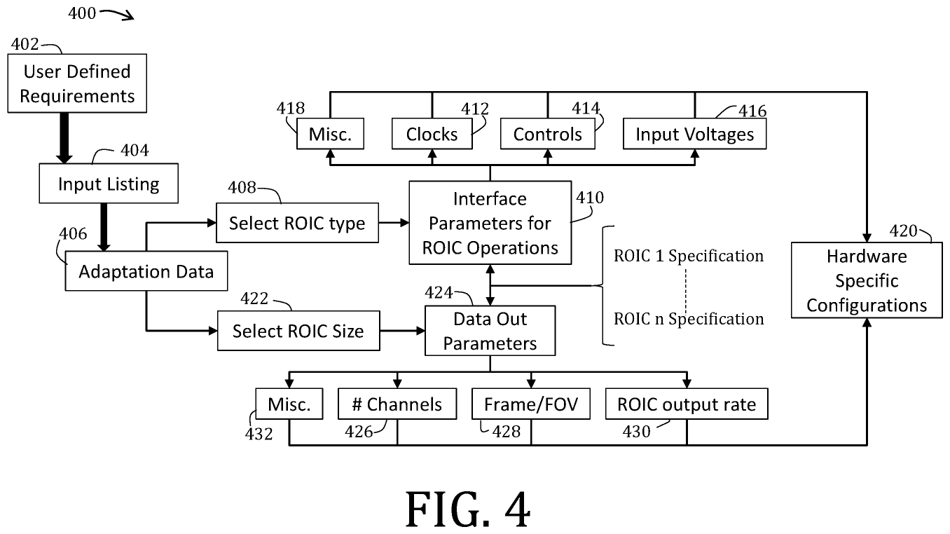

FIG. 4 graphically represents a method of generating a hardware specific configuration suitable for use in the PCE 202 of FIG. 3. Specifically, FIG. 4 depicts a method 400 by which the PCE 202 (FIG. 3) may be configured in accordance with a hardware configuration specific to or compatible with a desired or target ROIC or ROIC type. It is noted that the various steps associated with the method 400 of FIG. 4 may be performed by a PCE 202 (FIG. 3), the SCDAQ system 204 (FIG. 2), some other computing entity, or a combination thereof. The graphically represented method 400 of FIG. 4 may also be construed as an input selection diagram for hardware specific configurations.

Referring to FIG. 4, user-defined requirements 402 are used to generate an input listing 404 so as to define the adaptation data 406 for use with a desired or target ROIC or ROIC type.

A type of desired or target ROIC or ROIC type is selected 408 and used to define the interface parameters associated with corresponding ROIC operations 410. Such parameters may include, for example, clocks 412, controls 414, and input voltage 416, and miscellaneous operations parameters 418 as needed or required. These various interface parameters (clocks 412, controls 414, input voltages 416, and misc. 418) are defined in accordance with the specifications (illustrated as “ROIC 1 Specification” through “ROIC n Specification”) for each of a plurality of desired or target ROIC or ROIC types and are used to generate a portion of the hardware specific configuration ROIC operations 410 by which a universal ROIC interface is configured.

A size of the desired or target ROIC or ROIC type is selected 422 and used to define data output parameters 424 associated with corresponding ROIC operations 410. Such parameters may include, for example, a number of channels 426, a frame size or field of view 428, an ROIC output rate 430, and miscellaneous data parameters 432 as needed or required. These various data output parameters (number of channels 426, frame or field of view (FOV) 428, output rate 430, and misc. 432) are defined in accordance with the specifications for each of a plurality of desired or target ROIC or ROIC types and are used to generate a portion of the hardware specific configuration ROIC operations 420 by which a universal ROIC interface is configured.

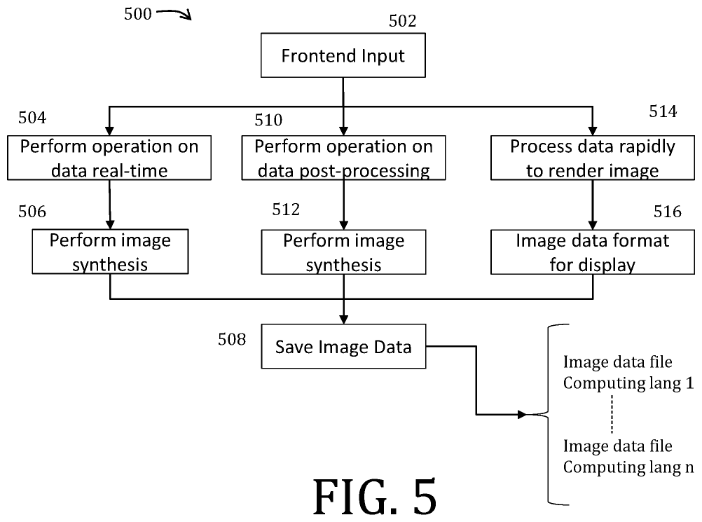

Referring now to FIG. 5, a method of generating an output image data file suitable for use in the PCE 202 of FIG. 3 is shown. Specifically, FIG. 5 depicts a method 500 by which the PCE 202 may be configured in accordance with a hardware configuration specific to or compatible with retrieving a processing data from desired or target ROIC or ROIC type. It is noted that the various steps associated with the method 500 of FIG. 5 may be performed by the PCE 202, the SCDAQ system 204 (FIG. 2), some other computing entity, or a combination thereof. The graphically represented method 500 of FIG. 5 may also be construed as a flow diagram of a method for image processing.

Referring to FIG. 5, frontend input image data collected or to be collected 502 is to be processed according to one or processing steps before being saved, offloaded, and/or otherwise utilized. Some or all of the collected image data may be subjected to real-time image processing operations 504, followed by an image synthesis operation 506 before being saved 508. Some or all of the collected image data may be subjected to postprocessing image processing operations 510, followed by an image synthesis operation 512 before being saved 508. Some or all of the collected image data may be subjected to image rendering operations 514, followed by image data display formatting 516 before being saved 508.

The saved image data or data sets may be used to provide image data such as according to various image data files in multiple computing languages, (illustrated as “Computing lang 1” through “Computing lang n”) data formats or other means of representation. For example, image data may be received from the PCE 202 (FIG. 3) and displayed on a display device of a computer, saved as a file associated with the computer, provided to an image processing program or system, and or utilized in any other manner.

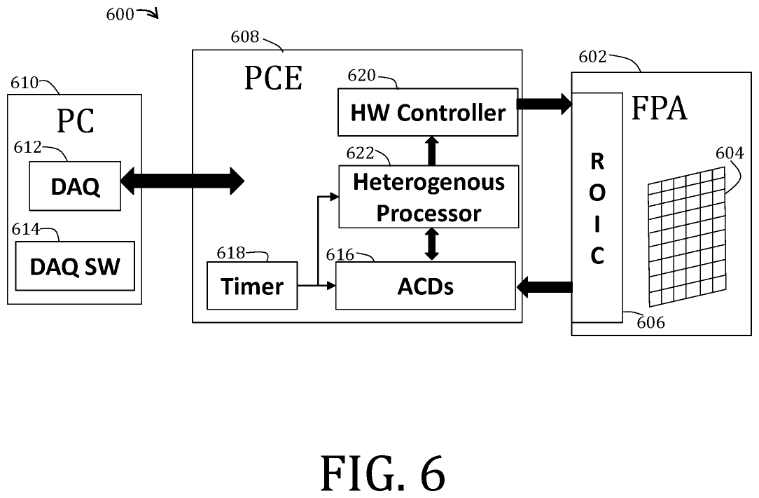

FIG. 6 is a high-level subsystem block diagram of a passive Electro-Optical/Infra-Red (EO/IR) imager 600 in accordance with one embodiment of the present invention. In FIG. 6, the passive EO/IR imager 600 has three subsystems. A frontend subsystem comprises a FPA subsystem 602 including a detector array 604 bonded to an ROIC 606. A PCE 608 is configured to capture and format data from the FPA subsystem 602 and provide that data to a backend computing subsystem 610 (illustrated as “PC”). The computing subsystem 610 is configured to enable DAQ 612 or DAQ SW 614 and may include a PC or single board computer configured to display the image or perform post capture analysis.

The PCE 608 is depicted as including analog to digital converters (ADCs) 616 configured to digitize analog data such as image data received from the ROIC 606 in accordance with timing information from a timer 618 and a hardware controller 620 from a heterogeneous processing element 622. Operation of the ROIC 606 may be controlled via hardware controller 620 within the PCE 608, wherein the hardware controller 620 may be configured for different types of ROICs as discussed herein. The PCE 608, such as via the heterogeneous processing element 622, communicates with the DAQ 612 to provide data thereto (e.g., image data) and receive instructions therefrom (e.g., type of ROIC and related ROIC configuration parameters).

Generally speaking, a signal processing subsystem (e.g., camera hardware) is defined here as a combination of the subsystem PCE 608 and the computer subsystem 610. While the detector array 604 is configured to sense optical radiation, the ROIC 606 defines the performance of the FPA subsystem 602. Therefore, the ability to interface with, control, and test ROICs for system design is essential. The majority of ROICs used are COTS, and most of the signal processing and rendering hardware and software are also COTS and not specialized towards a certain FPA and ROIC combination. In order to be a turnkey system, the camera hardware is designed to accommodate most general hardware utilizing multiple cards and cable options and is not targeted for a small footprint, low power, or customized for a particular ROIC.

The various embodiments enable a re-sequenceable power system to be controlled by a reconfigurable processing system that is ROIC agile. ROICs depend on the size of the FPA (Medium vs HD format, etc.), various power signals required to bias them, and the control and data signals (refer to FIG. 4 ROIC operations 410 and data output parameters 424). Once the power requirements are identified for most of the popularly used ROICs, the power system may be designed to incorporate the most commonly used voltages. The power system may be designed to be capable of being re-sequenced to ensure the power-up and power-down requirements of the majority of ROICs are addressed.

In various embodiments, other than the power system, most of the PCE will be a digital design and for any synchronous digital design the foremost requirement is the clock and a clock management system for multiple clock domains. The clocking requirements for ROICs and digitization will also vary. This can be handled via a heterogeneous processor or with an FPGA (field programmable gate array), as most of these firmware reconfigurable chips will have the capability to produce multiple clocks from a single clock or set of clocks, which may be usually phase locked or delay locked with each other to ensure signal propagation without loss of data.

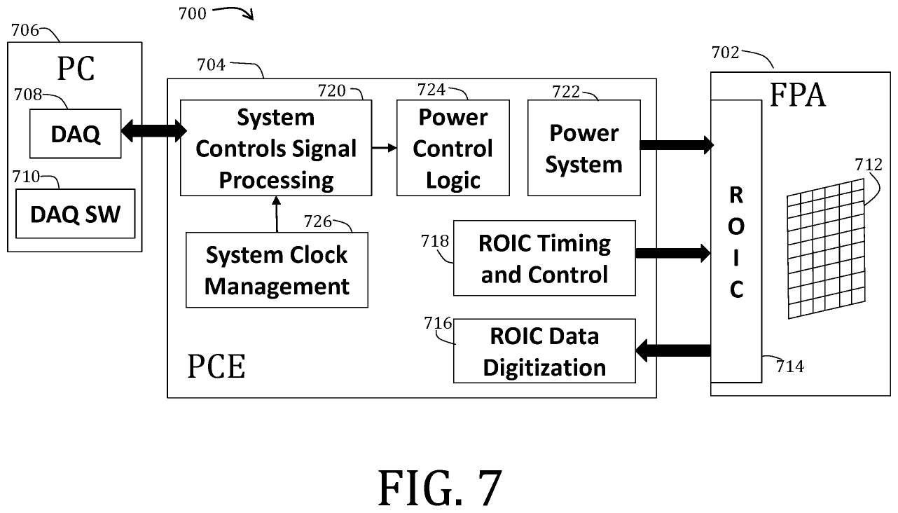

FIG. 7 is a high-level block diagram for a system 700 according to another embodiment of the present invention and including an FPA subsystem 702, a PCE subsystem 704, and a computing subsystem 706 (illustrated as “PC”). The output data rate of various ROICs is analyzed and a range of data rates is established to ensure that the target ROIC output can be digitized with a single device or footprint compatible device to expedite upgrade and or re-configurability. The digitized data is then processed and formatted for the computer subsystem 706 (with a DAQ 708 and DAQ SW 710). The computing system 706 is selected to ensure that the bandwidth requirements for the various ROIC data rates are met. Additionally, those computing subsystem 706 is determined to be more commonly used than others in various industries (e.g., automotive, automated production plants, and the like) or have a long product life span are preferentially targeted so as to minimize obsolescence issues.

The frontend subsystem with the FPA subsystem 702 includes a detector array 712 bonded to a ROIC 714. A PCE subsystem 704 is configured to capture and format data from the FPA 702 and provide that data to a backend computing subsystem 706. The computing subsystem 706 is configured to enable the DAQ 708 or DAQ SW 710, such as a PC or single board computer, to display the image or perform post capture analysis.

The PCE 704 is depicted as including a ROIC data digitization module 716 configured to digitize analog data such as image data received from the ROIC 714 in accordance with timing information from a ROIC timer and control module 718 and control information from a system controls and signal processing module 720. Operation of the ROIC 714 may be controlled via a ROIC timing and control module 718 within the PCE 704, along with the power system 722 as controlled by the power control logic 724, both of which conform the PCE operation to the particular control signals, control signal power levels, control signal timing requirements and so on associated with a target ROIC or ROIC type. A system clock management module 726 provides fundamental timing and clock information or signals which are provided to other modules as appropriate via the systems control and signal processing module 720. The PCE 704 communicates with the computing subsystem 706 to provide data thereto (e.g., image data) and receive instructions therefrom (e.g., type of ROIC and related ROIC configuration parameters).

Thus, as described herein with respect to the various figures, various embodiments contemplate a single board reconfigurable signal processing architecture that includes: (i) an analog input stage comprising of multiple amplification and signal isolation channels with capability of utilizing single or multiple channels for incoming analog signal(s) from an optical frontend of an imaging sensor consisting of a detector array and a ROIC; (ii) a digitization stage comprising of analog to digital convertors for digital conversion of incoming analog signals with capability of utilizing single or multiple channels for digitization of analog signal/s; and (iii) in the case of a digital ROIC, a dedicated bus from a DROIC (Digital Read-Out Integrated Circuit) interface to host processors.

FPGAs or heterogeneous processors with memory and programs may also be provided, where the programs can be stored in the memory and configured to be executed by FPGAs or heterogeneous processors. The programs may include instructions for: generating signals for hardware control of the optical frontend and any configurable hardware within the signal processing architecture and timing signals for digital logic used in generation of these signals; output signal drivers to provide signal strength to take signals from the signal processor to the standalone controller (SCDAQ); instantiation of power sources required for the amplifier, digitizer, heterogeneous processor, and output signal drivers; and instantiation of power sources required for multiple ROIC and detector array requirements for powering an optical frontend.

In one or more embodiments of the single board reconfigurable signal processing architecture, the power sources required for ROICs may be re-sequenced for powering up and powering down of ROIC for different instantiations of optical frontends using varying ROICs and detector arrays.

In one or more embodiments of the single board reconfigurable signal processing architecture, the timing control will include multiple timing sources that can be used to generate multiple sub-harmonic signals.

In one or more embodiments of the single board reconfigurable signal processing architecture, one processor of the FPGAs or heterogeneous processors is configured to communicate with a computing device, such as a PC or single board computer. In one or more embodiments, the single board reconfigurable signal processing architecture includes one processor of the FPGAs or heterogeneous processors have stored therein instructions that, when executed, implement image processing techniques on the incoming image data. In one or more embodiments of the single board reconfigurable signal processing architecture, one processor of the one or more FPGAs and/or heterogeneous processors configured to communicate with a ROIC.

In one or more particular embodiments, one processor of the FPGAs or heterogeneous processors is configured to perform a method to receive data from digitization stage and provides the instructions to formats the outgoing data in a format required by the receiving computing device for rendering or post processing. In one or more particular embodiments, one processor of the FPGAs or heterogeneous processors is configured to perform a method to receive information from a computing device implementing various image collection schemes allowed by an instantiation of a ROIC. In one or more particular embodiments, one processor of the FPGAs or heterogeneous processors is configured to perform a method to store image data on-board within a memory that may be read by the FPGAs or heterogeneous processors at a later instance in time.

In one or more particular embodiments, the FPGAs or heterogeneous processors is configured to perform a method to receive information from a computing device to configure and implement control signals for different instantiations of ROICs. In one or more specific embodiments, the FPGAs or heterogeneous processors is configured to perform a method to control ROICs for varying sizes of detector arrays. In one or more very specific embodiments, the FPGAs or heterogeneous processors is configured to perform a method to control ROICs that require different timing for data and control signals including the Built in Test (BIT) capabilities for developmental, COTS, and tactical ROICs.

Various embodiments provide a dedicated, custom, reconfigurable architecture for signal processing subsystem for Infrared Imagers. This architecture is designed to have smaller footprints and lower cost than the current commercial systems used for IR imaging. The low C-SWAP for this architecture design makes it suitable for attritable and expendable platforms. Such embodiments allow use of the same subsystem through lab, field-, and flight-testing platforms, thus providing a clear path for technology transition. The various embodiments also provide a capability to interface, control, and test ROIC from multiple ROIC designers and provide a lower-cost alternative to upgrading/replacing proprietary turnkey imaging systems.

Some or all of the of the various elements included within the various embodiments of the PCE may be implemented in whole or in part by hardware or a combination of hardware and software via computing blocks or processing elements, such as FPGAs or similar, or via controllers including processor(s), tangible and non-transitory computer readable medium such as memory, input/output (I/O) circuitry and the like. That is, the functionality described herein with respect to the PCE may be provided via one or more computing devices including a processor element (e.g., a central processing unit (CPU) and/or other suitable processor(s)), a memory (e.g., random access memory (RAM), read only memory (ROM), and the like), various cooperating modules/processes such as special purpose clock or power control modules, and various input/output devices or interfaces.

Thus, it will be appreciated that at least some of the functions depicted and described herein may be implemented application specific integrated circuits (ASICs), FPGSs, or any other hardware equivalents. It is contemplated that some of the steps discussed herein may be implemented within hardware, for example, as circuitry that cooperates with the processor to perform various steps or functions as described herein. Portions of the functions/elements described herein may be implemented as a computer program product wherein computer instructions, when processed by a computing device, adapt the operation of the computing device such that the methods and/or techniques described herein are invoked or otherwise provided. Instructions for invoking the inventive methods may be stored in tangible and non-transitory computer readable medium such as fixed or removable media or memory, and/or stored within a memory within a computing device operating according to the instructions.

Thus various embodiments of the invention provide a universal ROIC interface apparatus configurable to control a target ROIC from different types of ROICs, each of the different types of ROIC being configured to operate as an optical frontend to a respective optical detector array, the universal ROIC interface comprising: a PCE system, comprising: a power subsystem configured to generate for the target ROIC type a power signal having a selected power level; a ROIC data receive interface configured to provide a plurality of available physical layer channels for coupling to a corresponding plurality of ROIC physical layer output channels for receiving from the target ROIC an optical intensity level representative electrical signal; a clock management system configured to generate for the target ROIC a clock signal configured to enable communication between the ROIC data receive interface and the target ROIC; and a signal processor configured to receive control information associated with the target ROIC and responsively configure the power subsystem, the ROIC data receive interface, and the clock management system. The generated power signal may be configured to be sequenced for boot up or shut down requirements of the target ROIC. The plurality of available physical layer channels may comprise digital signal input channels. The plurality of available physical layer channels may comprise analog signal input channels. The clock management system may comprise a plurality of programmable clock generators configured to generate the clock signals enabling communication between the ROIC data receive interface and the target ROIC.

The signal processor may include one or more processors with tangible and non-transitory computer readable memory including instructions which, when executed by the one or more processors, configure the signal processor to receive control information associated with the target ROIC and responsively configure the power subsystem, the ROIC data receive interface, and the clock management system. The instructions, when executed by the one or more processors, may configure the signal processor to generate signals for hardware control of the optical frontend, or of the clock management system, or configure the signal processor to generate signals for instantiation of power sources required for amplifier, digitizer, heterogeneous processor, and output signal drivers. The instructions, when executed by the one or more processors, may configure the signal processor to generate signals for instantiation of power sources required for multiple ROIC and detector array requirements for powering an optical frontend.

Various embodiments of the invention provide a single board reconfigurable signal processing architecture, comprising: an analog input stage comprising a plurality of available amplification and signal isolation channels configured to receive respective analog signals from an optical frontend of an imaging sensor consisting of a detector array and a ROIC; a power subsystem configured to generate for the target ROIC type a power signal having a selected power level; a ROIC data receive interface configured to provide a plurality of available physical layer channels for coupling to a corresponding plurality of ROIC physical layer output channels for receiving from the target ROIC an optical intensity level representative electrical signal; a clock management system configured to generate for the target ROIC a clock signal configured to enable communication between the ROIC data receive interface and the target ROIC; and a signal processor configured to receive control information associated with the target ROIC and responsively configure the analog input stage, the power subsystem, the ROIC data receive interface, and the clock management system.

The signal processor may be implemented using a FPGA configured to adapt the signal processing architecture in response to a target ROIC. A dedicated bus for communicating between a digital ROIC (DROIC) interface and the host processors may be used. The power subsystem may be configured to be re-sequenced for powering up and powering down of ROIC for optical frontends having different ROIC and detector array combinations. The clock management system may include multiple timing sources that can be used to generate multiple sub-harmonic signals.

The signal processor may be capable of communicating with a computer, such as a DAQ or DAQ SW, and may reformat received ROIC data into a format required by the DAQ or DAQ SW. The signal processor may configure the analog input stage, the power subsystem, the ROIC data receive interface, and the clock management system in accordance with an application received from the DAQ or DAQ SW. The application may comprise at least one of an image collection application, an optical array powering application, and an optical array scanning application. The signal processor may be associated with memory configured to store image data. The signal processor may be configured to implement control signals for different types of ROICs and for different sizes of detector arrays, or to provide a built-in test capability for commercial off-the-shelf (COTS) ROICS.

Through a hardware development task, various embodiments enable for designing in-house equipment and expertise to develop sensor specific reconfigurable signal processing subsystem in a single board configuration that can be used with multiple FPAs such as those provided by Black Forest Engineering, Voxtel, and others, in addition to the current commercial off the shelf, state of the art, which are ROICs manufactured by companies such as FLIR Systems, with minimum or no modifications. This competing values framework task extends the subsystem design work into the electro-optics field and opens new avenues of research into compact imaging architectures for both lab and field testing of single and multi-spectral imaging.

While the invention has been described with reference to exemplary embodiments, it will be understood by those skilled in the art that various changes may be made, and equivalents may be substituted for elements thereof without departing from the scope of the invention. In addition, many modifications may be made to adapt a particular system, device, or component thereof to the teachings of the invention without departing from the essential scope thereof. Therefore, it is intended that the invention be limited to the particular embodiments disclosed for carrying out this invention, but that the invention will include all embodiments falling within the scope of the appended claims. Moreover, the use of the terms first, second, etc. do not denote any order or importance, but rather the terms first, second, etc. are used to distinguish one element from another.

In the preceding detailed description of exemplary embodiments of the invention, specific exemplary embodiments in which the disclosure may be practiced are described in sufficient detail to enable those skilled in the art to practice the disclosed embodiments. For example, specific details (such as specific method orders, structures, elements, and connections) have been presented herein. However, it is to be understood that the specific details presented need not be utilized to practice embodiments of the present invention. It is also to be understood that other embodiments may be utilized, and that logical, architectural, programmatic, mechanical, electrical, and other changes may be made without departing from the general scope of the invention.

What is claimed is:

1. A Pulse Capture Electronics (PCE) system configured to control a target Read-Out Integrated Circuit (ROIC), the target ROIC being configured to operate as an optical frontend to a respective optical detector array, the PCE comprising:
an ROIC data receive interface configured to provide a plurality of available physical layer channels for coupling to a corresponding plurality of ROIC physical layer output channels for receiving an optical intensity level representative electrical signal from the target ROIC;
a clock management system configured to generate a clock signal for the target ROIC, the clock signal configured to enable communication between the ROIC data receive interface and the target ROIC; and
a signal processor configured to receive control information associated with the target ROIC and responsively configure the ROIC data receive interface, the clock management system, or both.

2. A universal Read-Out Integrated Circuit (ROIC) interface configurable to control a target ROIC, the target ROIC being configured to operate as an optical frontend to a respective optical detector array, the universal ROIC interface comprising:
a Pulse Capture Electronics (PCE) system, comprising:
an ROIC data receive interface configured to provide a plurality of available physical layer channels for coupling to a corresponding plurality of ROIC physical layer output channels for receiving an optical intensity level representative electrical signal from the target ROIC;
a clock management system configured to generate a clock signal for the target ROIC, the clock signal configured to enable communication between the ROIC data receive interface and the target ROIC; and
a signal processor configured to receive control information associated with the target ROIC and responsively configure the ROIC data receive interface, the clock management system, or both.

3. The universal ROIC interface of claim 2, wherein the PCE system further comprises:
a power subsystem configured to generate a power signal for the target ROIC, the power signal having a selected power level, and wherein the signal processor is further configured responsively configure the power subsystem.

4. The universal ROIC interface of claim 3, wherein the generated power signal is configured to be sequenced for boot up or shut down requirements of the target ROIC.

5. The universal ROIC interface of claim 3, wherein the signal processor includes a processor having tangible and non-transitory computer readable memory including instructions which, when executed by the processor, configure the signal processor to receive a control information associated with the target ROIC and responsively configure the power subsystem, the ROIC data receive interface, and the clock management system.

6. The universal ROIC interface of claim 5, wherein the instructions, when executed by the processor, configure the signal processor to generate signals for hardware control of the optical frontend.

7. The universal ROIC interface of claim 5, wherein the instructions, when executed by the processor, configure the signal processor to generate signals for hardware control of the clock management system.

8. The universal ROIC interface of claim 5, wherein the instructions, when executed by the processor, configure the signal processor to generate signals for instantiation of power sources required for amplifier, digitizer, heterogeneous processor, and output signal drivers.

9. The universal ROIC interface of claim 5, wherein the instructions, when executed by the processor, configure the signal processor to generate signals for instantiation of power sources required for multiple ROIC and optical detector array requirements for powering the optical frontend.

10. The universal ROIC interface of claim 2, wherein the plurality of available physical layer channels comprise digital signal input channels.

11. The universal ROIC interface of claim 2, wherein the plurality of available physical layer channels comprise analog signal input channels.

12. The universal ROIC interface of claim 2, wherein the clock management system comprises a plurality of programmable clock generators configured to generate the clock signals enabling communication between the ROIC data receive interface and the target ROIC.

13. A single board reconfigurable signal processing architecture, comprising:
an analog input stage comprising a plurality of available amplification and signal isolation channels configured to receive respective analog signals from an optical frontend of an imaging sensor consisting of a detector array and a Read-Out Integrated Circuit (ROIC);
a power subsystem configured to generate for the target ROIC a power signal having a selected power level;
a ROIC data receive interface configured to provide a plurality of available physical layer channels for coupling to a corresponding plurality of ROIC physical layer output channels for receiving from the target ROIC an optical intensity level representative electrical signal;
a clock management system configured to generate for the target ROIC a clock signal configured to enable communication between the ROIC data receive interface and the target ROIC; and
a signal processor configured to receive control information associated with the target ROIC and responsively configure the analog input stage, the power subsystem, the ROIC data receive interface, and the clock management system.

14. The single board reconfigurable signal processing architecture of claim 13, wherein the signal processor is implemented using a field programmable gate array (FPGA) configured to adapt the signal processing architecture in response to a target ROIC.

15. The single board reconfigurable signal processing architecture of claim 13, further comprising a dedicated bus for communicating between a digital ROIC (DROIC) interface and a host processor.

16. The single board reconfigurable signal processing architecture of claim 13, wherein the power subsystem is configured to be re-sequenced for powering up and powering down of ROIC for optical frontends having different ROIC and optical detector array combinations.

17. The single board reconfigurable signal processing architecture of claim 13, wherein the clock management system includes multiple timing sources that can be used to generate multiple sub-harmonic signals.

18. The single board reconfigurable signal processing architecture of claim 13, wherein the signal processor is capable of communicating with a computer.

19. The single board reconfigurable signal processing architecture of claim 13, wherein the signal processor receives data from a ROIC data receive interface and reformats the received data to provide output data for a Data Acquisition (DAQ) system in a format required by the DAQ system.

20. The single board reconfigurable signal processing architecture of claim 19, wherein the signal processor configures the analog input stage, the power subsystem, the ROIC data receive interface, and the clock management system in accordance with an application received from the DAQ system.

21. The single board reconfigurable signal processing architecture of claim 19, wherein the application comprises at least one of an image collection application, an optical array powering application, and an optical array scanning application.

22. The single board reconfigurable signal processing architecture of claim 13, wherein the signal processor is associated with memory configured to store image data.

23. The single board reconfigurable signal processing architecture of claim 13, wherein the signal processor is configured to implement control signals for different types of ROICs and for different sizes of detector arrays.

24. The single board reconfigurable signal processing architecture of claim 13, wherein the signal processor is configured to provide a built-in test capability for commercial off-the-shelf (COTS) ROICs.
